(19) United States
(12) Patent Application Publication
(10) Pub. No.: US 2004/0249771 A1
(43) Pub. Date: Dec. 9, 2004

(54) Method of providing a unique identifier for a mailpiece

(76) Inventors: Lisa Berg, Willowbrook, IL (US); John Julitz, Plainfield, IL (US); Kurt Konow, Naperville, IL (US); Colleen Sall, Naperville, IL (US); Corland D. Starrett, Brookstone, IL (US); Gerald L. Taylor, Plainfield, IL (US)

Correspondence Address: Pitney Bowes Inc., Intellectual Property & Technology Law Department, 35 Waterview Drive, P.O. Box 3000, Shelton, CT, 06484, US

(21) Appl. No.: 10/738,768

(22) Filed: Dec. 17, 2003

Related U.S. Application Data
(60) Provisional application No. 60/436,350, filed on Dec. 24, 2002.

(51) Int. Cl. G06F 17/00; G07B 17/02

(52) U.S. Cl. 705/401

(57) ABSTRACT

A method for generating a PLANET service code for a batch of mailpieces with the PLANET service code having assignable digits. The method includes the steps of retrieving a time of day from a clock source and prescribing the assignable digits based upon the retrieved time of day. Next the PLANET service code having the assignable digits is associated with a mailpiece from the batch of mailpieces, which information is also preferably stored in a database for subsequent mailpiece tracking purposes. A determination is then made as to whether another mailpiece is present in the batch of mailpieces, and if yes, the aforesaid assignable digit is incremented by a one count. This once again incremented assignable digit value is then associated with the PLANET service code for the another present mailpiece.

### CROSS REFERENCE TO RELATED APPLICATION

This application claims priority under 35 U.S.C. section 119 (e) from Provisional Patent Application Ser. No. 60/436,350, filed Dec. 24, 2002, entitled SYSTEM AND METHOD FOR TRACKING MAILIPIECES (Attorney Docket Number F-613) which is incorporated herein by reference in its entirety.

### FIELD OF THE INVENTION

The present invention relates to a method for tracking a mailpiece in a postal processing system. More particularly, the present invention relates to a method for providing a unique identifier to a mailpiece that is used for tracking the mailpiece through a postal processing system.

### BACKGROUND OF THE INVENTION

Mailpieces have traditionally used barcodes to control mailpiece inserting and sorting operations. Barcodes are also used on a mailpiece to facilitate delivery of the mailpiece. For example, a POSTNET barcode placed on a mailpiece is used by the United States Postal Service to control delivery of a mailpiece in a mainstream. A POSTNET barcode typically is formed by either a 9 or 11 digit zip code that corresponds to a specific geographic region designated by the United States Postal Service for facilitating mailpiece delivery. Thus, all mail recipients in such a specific geographic region may be assigned a common POSTNET.

Recently, the United States Postal Service has implemented the use of PLANET codes to track mail electronically once the mailpiece enters the mail stream. The United States Postal Service offers two types of PLANET code services, namely origin CONFIRM and destination CONFIRM. Both of which are briefly described below.

The Origin CONFIRM service enables a mailer to access data regarding when a return mailpiece has been sent, typically in the format of a business reply mailpiece. The mainstream sortation equipment of the United States Postal Service scans the mail as part of sorting and routing the mail throughout the U.S. and allows a customer to access information regarding when a return mailpiece has been mailed. Each time the mailpiece is scanned as part of the sortation process the information (e.g., POSTNET and PLANET code barcodes) is recorded in a USPS confirm server. The mailer then has access to the data (multiple instances of) located on the USPS confirm server. For example, the United States Postal Service can provide code readers that read POSTNET and PLANET codes from mailpieces at various locations in the mail stream. For example, these readers are located at postal service mail sorting sites. These readers can be in communication with the United States Postal Service CONFIRM server, which logs into the confirm server database the date, time and location when a particular mailpiece passes through the multiple postal service mail delivery stream scan point locations. Thus, the origin CONFIRM service can be used to verify that a communication has been remitted by a customer.

When using origin CONFIRM service, the mailpiece includes both a POSTNET and PLANET code barcode. The POSTNET barcode is the POSTNET assigned by the United States Postal Service for the mailer's location. And the origin CONFIRM barcode is a 12 or 14 digit barcode where the first two digits represent the PLANET barcode being used for origin CONFIRM service with the next 9 or 11 digits identifying the mailpiece to the mailer (as chosen by the mailer), and the last digit is a check-sum digit that helps the United States Postal Service detect errors.

Regarding the destination CONFIRM service, it enables mailers to access the confirm database of the United States Postal Service to access the date, time and scan point of the mailpiece being routed to the customer. The mailer can get access to the time the mailpiece was delivered to the carrier for delivery to the customer. As with the origin CONFIRM service, the destination CONFIRM service can be implemented by the Postal Service using the same readers described above and a server to communicate destination confirmation information to the mailer.

Like the origin CONFIRM service, when using destination CONFIRM service, the mailpiece includes both a POSTNET and PLANET code barcode. The POSTNET barcode is the POSTNET assigned by the United States Postal Service for the recipient of the mailpiece being sent by the mailer. The destination CONFIRM barcode is a 12 or 14 digit barcode where the first two digits represents the PLANET barcode is being used for origin CONFIRM service with the next 9 or 11 digits identify the mailer and the mailpiece. Specifically, of these 9 or 11 digits, the first five digits is a unique (and fixed) 5-digit ID assigned by the United States Postal Service to identify mailers subscribed to the PLANET code service offering. The next four (4) or six (6) digit field is the mailing (or customer) ID that is defined by the mailer to identify a mailpiece to that mailer. Currently only a four (4) digit field is used for the mailing (or customer) ID.

Even though the PLANET code service offering is advantageous to mailers for enabling them to track outgoing (destination CONFIRM) and incoming (origin CONFIRM) mailpieces, it does have shortcomings. Notably, destination confirm only currently provides the mailer with a four (4) digit field for providing a unique ID for each mailpiece being sent. Thus, and especially on large volume mailings, the mailer cannot ensure uniqueness for mailpieces being delivered to the same address or addresses having the same POSTNET, and the customer ID suggestion can often cause duplicate PLANET codes from being delivered to the same customer across different mailings of the mailer and possible jeopardize a customers confidentiality by identifying the customer with a static customer ID. For example, single mailpieces going to separate addresses, like one person per household, the destination CONFIRM code can identify the exact mailpiece being tracked as to who should be receiving it. However, if the destination CONFIRM mailpieces are being delivered to multiple persons at a residence or business, then there is no way to tell who the tracking information belongs to as the PLANET and POSTNET codes are identical for each such person.

### SUMMARY OF THE INVENTION

An object of the present invention is to overcome the noted shortcomings of a PLANET code mailpiece by providing uniqueness to each PLANET code mailpiece delivered to recipients having a common POSTNET service code.

Another object of the present invention is to provide a method for generating PLANET service barcodes while not using static customer ID's.

The above objects of the present invention are accomplished by providing a method for generating a PLANET service code for a batch of mailpieces with the PLANET service code having assignable digits. The method includes the steps of retrieving a time of day from a clock source and prescribing the assignable digits based upon the retrieved time of day. Next the PLANET service code having the assignable digits is associated with a mailpiece from the batch of mailpieces, which information is also preferably stored in a database for subsequent mailpiece tracking purposes. A determination is then made as to whether another mailpiece is present in the batch of mailpieces, and if yes, the aforesaid assignable digit is incremented by a one count. This once again incremented assignable digit value is then associated with the PLANET service code for the another present mailpiece.

### BRIEF DESCRIPTION OF THE DRAWINGS

The above and other objects of the present invention will become apparent upon consideration of the following detailed description, taken in conjunction with the accompanying drawings, in which like reference numerals refer to like parts throughout, and in which:

FIG. 1 is an illustration of a mailpiece having a POSTNET and PLANET service barcode;

FIGS. 2 and 3 depict block diagrams of an exemplary system used for generating and processing PLANET service barcodes;

FIGS. 4a and 4b depict a flow-chart for generating a destination CONFIRM service code and an illustrative image of a destination CONFIRM barcode; and

FIGS. 5a and 5b depict a flow-chart for generating an origin CONFIRM service code and an illustrative image of an origin CONFIRM barcode.

### DETAILED DESCRIPTION OF THE PREFERRED EMBODIMENT

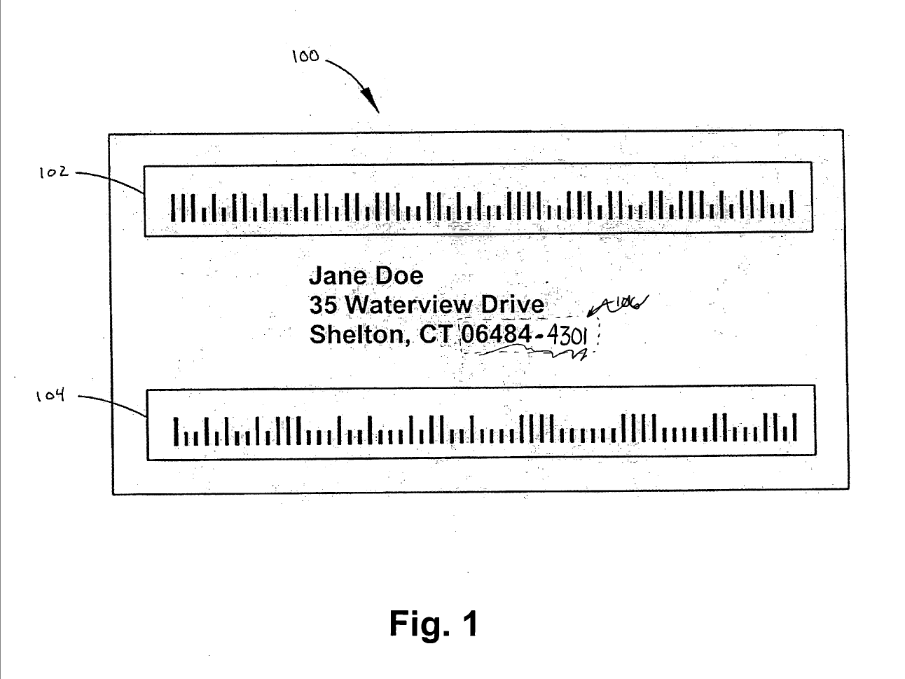

Referring to FIG. 1, exemplary postal service mailpiece codes suitable for use by the present invention is illustrated. Reference numeral 100 generally designates the address block of a conventional mailpiece. Such an address block can either be printed on the outside of an envelope or on a mailpiece inserted in an envelope such that address block 100 is visible through a window in the envelope. For the purposes of the present invention, address block 100 includes United States Postal Service PLANET code 102 and POSTNET code 104. PLANET code 102 is a bar code in which bars of varying height are used to encode any suitable information, such as a service type, a customer ID or mailing and subscriber ID and a checksum. The first two digits of the PLANET code typically indicate a desired service type. For example, according to current United States Postal Service standards, the digits 21 indicate origin CONFIRM and 22 indicates destination CONFIRM service, as previously explained.

As previously mentioned, it is an object of the present invention to provide a process that generates unique destination and origin CONFIRM barcodes for mailpieces, and preferably for each mailpiece present in a “mail batch.” Briefly, a “mail batch” is a batch of mailpieces generated by a mailer and targeted for a group of recipients. For example, a “mail batch” can consist of monthly credit card billing statements for a particular bank.

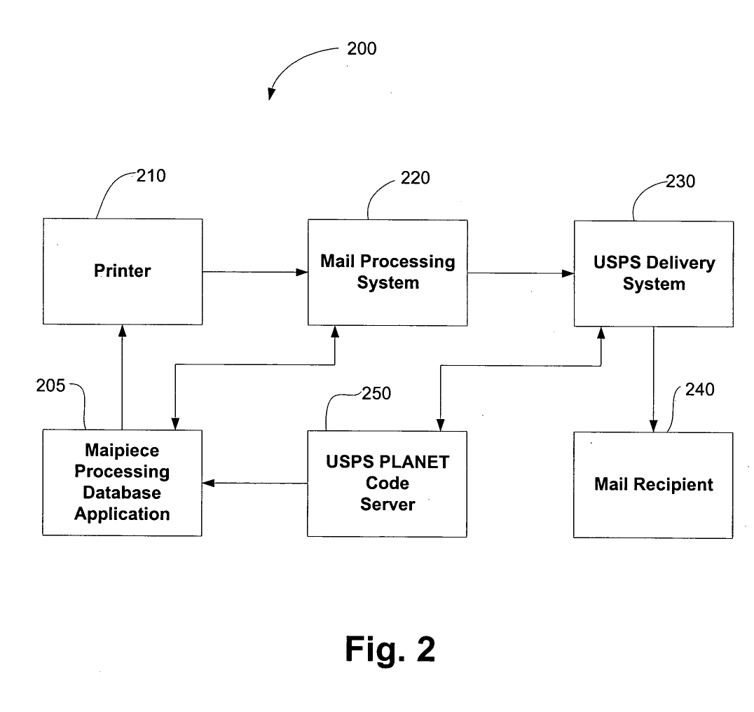

As shown in FIG. 2, there is illustrated an overall system for controlling mailpiece processing and tracking using a postal service mailpiece code according to an embodiment of the present invention. In FIG. 2, a mailpiece processing and tracking system, generally designated 200, includes components that create a mailpiece to be placed in a mail stream. For example, system 200 includes a mailpiece processing database application 205 that generates print data to be printed on a mailpiece. Such an application can be a computer program executing on a general purpose computer that generates the mailpiece print data. Such mailpiece data can include the actual information content of a mailpiece. For example, if the mailpiece is a bill, the print data can include the address of the recipient of the bill and the amount of the bill.

Typically, the mailpiece processing database application 205 is coupled to, or integrated with a print data manipulator that receives the print data from application 205. Like application 205, a print data manipulator can be a program executing on a general purpose computer. An example of a print data manipulator program suitable for use with the present invention is the StreamWeaver™ product commercially available from Pitney Bowes Inc. of Stamford, Conn. In response to receiving the print data, a print data manipulator can reformat and add additional print data, such as the PLANET code and POSTNET code, and deliver pertinent information to printer 210 and mailpiece processing database application 205. Mailpiece processing database application 205 stores the information received from print data manipulator in a mailpiece processing database 310 (as described below).

Preferably coupled to, or integrated with printer 210 is a mailpiece processing system or systems 220, such as an inserting system and sorter. Such an inserting system is responsible for inserting the correct materials in the correct envelopes. For example, mail to be delivered to telephone bill recipients may include one set of promotional inserts while mail to be delivered to car owners may include another set. Once a mailpiece is generated via mail processing system 220, the mailpiece enters the United States Postal Delivery System 230, which delivers the mailpiece(s) to intended recipients 240 via its POSTNET barcode and also tracks the mailpiece for the mailer via the PLANET code barcode. To enable mailpiece tracking, the United States Postal Service delivery system 230 is provided with a PLANET code server 250 that selectively communicates tracking information from the mail stream of the United States Postal Service to preferably a mailer's mailpiece processing database application 205.

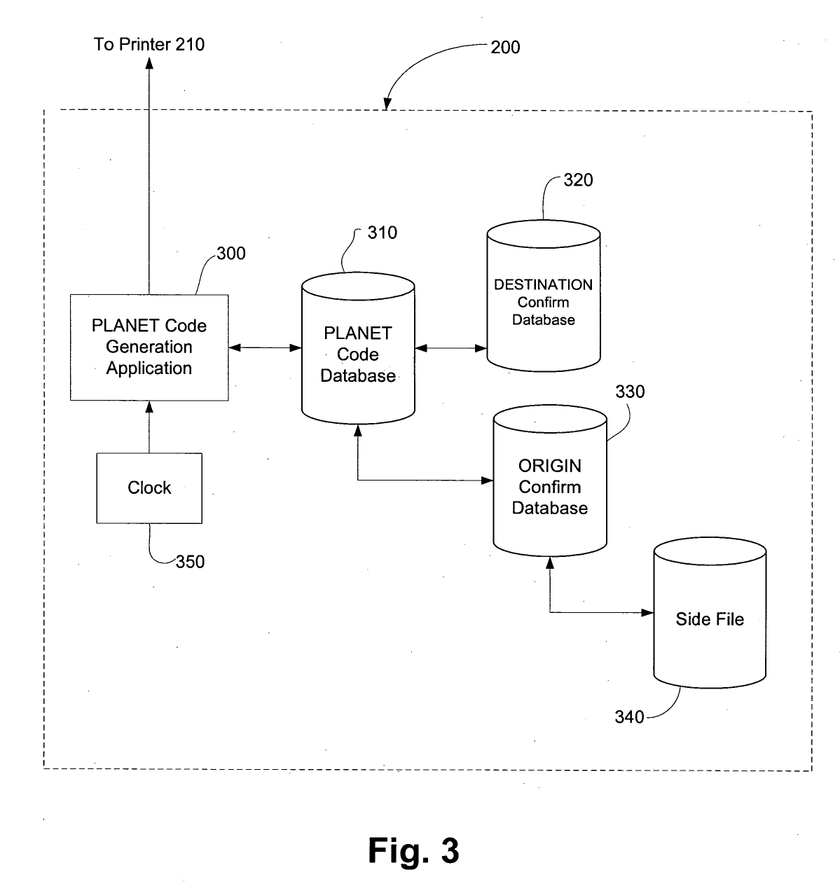

Referring now to FIG. 3, the mailpiece processing database application 200 is shown in more detail. It preferably consists of a PLANET code generation application 300 that is preferably a software program used for generating either origin or destination CONFIRM barcodes. Once generated, these barcodes are preferably stored in a database structure for later retrieval for mailpiece tracking purposes. As the database structure may vary greatly, for ease of description of the present invention an exemplary database structure is shown. Thus, the present invention is not to be understood to be limited to what is shown in FIG. 3 but may encompass any suitable database structure meeting the needs of a user. In this exemplary embodiment, a PLANET code database 310 stores all generated PLANET codes preferably in correlation with associated mailpieces. Database 310 preferably includes sub-databases, namely a destination CONFIRM database 320 for storing generated destination CONFIRM barcodes (as described below) and an origin CONFIRM database 330 for storing generated origin CONFIRM barcodes (as also described below). The origin CONFIRM database 330 preferably also includes a sub-database 340, the function of which will be described below. A clock source 350 is also provided with, or coupled to the PLANET code generation application 300.

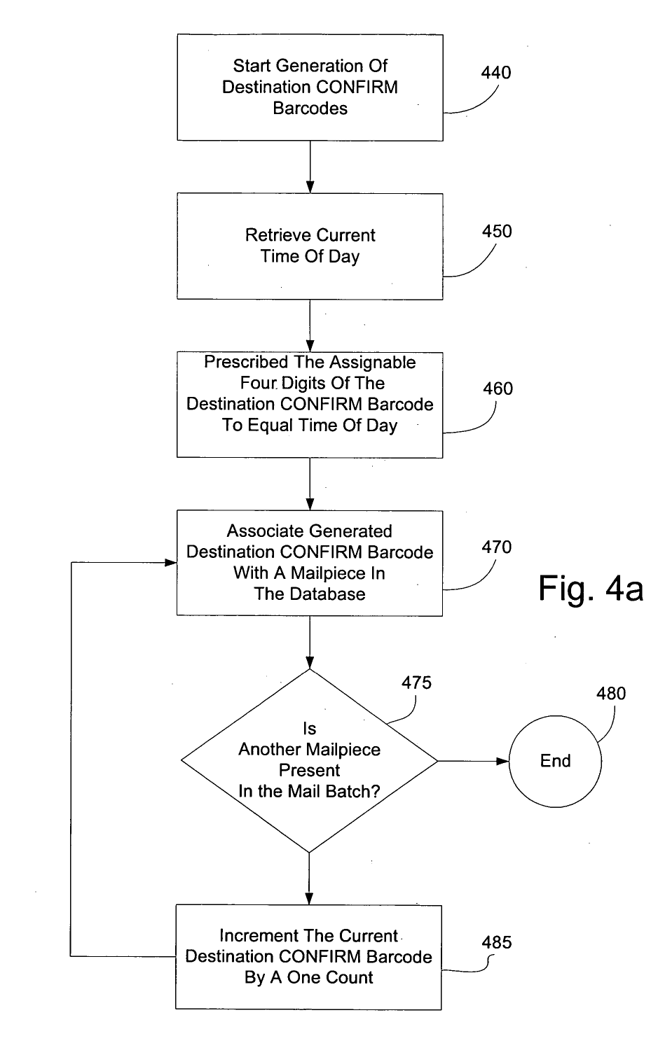

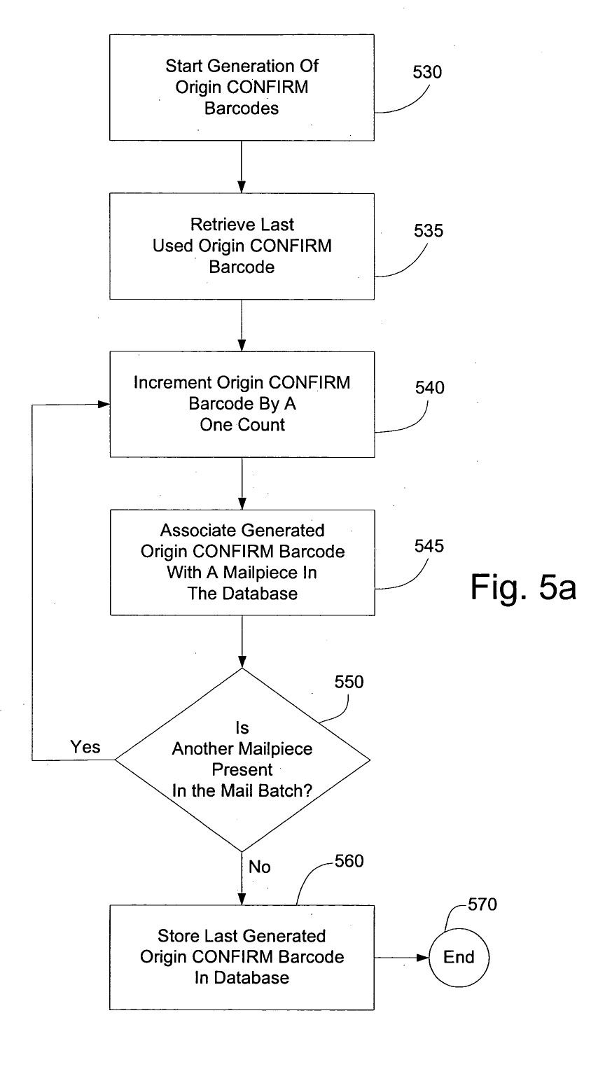

With reference now to FIGS. 4a, 4b, 5a and 5b, the method for generating origin and destination PLANET service codes will now be described.

First, with specific reference to FIGS. 4a and 4b, the method for generating a destination PLANET service code will now be described. As previously mentioned, the destination CONFIRM barcode 400 is currently a barcode wherein the first two digits 410 designate that the PLANET service barcode is being used for destination CONFIRM service, the next first five digits 420 is a unique (and fixed) 5-digit ID assigned by the United States Postal Service to identify mailers subscribed to the PLANET code service offering. And the next four (4) digit field 430 is the mailing (or customer) ID that is defined by the mailer to identify a mailpiece to that mailer. It is this four digit field 430 that is assignable by the mailer and enables the mailpiece to be uniquely identifiable to the mailer.

The method for generating the assignable four digit field 430 starts at step 440 in which the PLANET code generation application 300 (FIG. 3) receives a command to start generating destination CONFIRM barcodes 400, preferably for a batch of mailpieces to be mailed by a mailer. Beginning at step 450, PLANET code generation application 300 retrieves the current minutes and seconds of the time of day from the clock source 350. For instance, if the current time of day is 12:05.45 pm, the PLANET code generation code application 300 is provided with the digits 0545 from clock 350. Next, the initial four digits for the assignable four digit field 430 is prescribed to be equal to the aforementioned retrieved current minutes and seconds for the time of day (e.g., 0545), step 460. The current four digits for the assignable four digit field 430 is then associated with a particular mailpiece and preferably stored in the destination CONFIRM database 320 (FIG. 3), step 470. A determination is then made as to whether another mailpiece is present in the batch of mail requiring a destination CONFIRM barcode, step 475. If no, then this process ends, step 480, and will repeat itself when another batch of mail requiring destination CONFIRM barcodes is to be sent by the mailer, step 440.

It is to be appreciated that utilizing the current minutes (MM) and seconds (SS) of the time of day as reference point for the four assignable digits 430 encompasses the preferred embodiment of the present invention. However, the present invention is not to be understood to be limited to using the current minutes (MM) and seconds (SS) of the time of day as reference point for the four assignable digits 430 but rather may use various values from the current time of day (e.g., current hours (HH) and minutes (MM)) so as to prescribe the starting point for the four assignable digits.

If another mailpiece is present in the batch of mail, step 475, then the current four digits for the assignable four digit field 430 is increased by a one count (e.g., 0546), step 485, and the process returns to step 470 for this next mailpiece. Thus, the utilization of the current minutes and seconds of the time of day ensures uniqueness for mailpieces and especially for subsequent mailpieces being delivered to the same address.

With reference now to FIGS. 5a and 5b, the method for generating a origin CONFIRM barcode will now be described. As previously mentioned, the origin CONFIRM barcode 500 is currently a barcode wherein the first two digits 510 designate that the PLANET barcode is being used for origin CONFIRM service, the next nine digits 520 identify the mailpiece to the mailer, which is prescribed by the mailer. It is this nine digit field 520 that is assignable by the mailer and enables a return mailpiece to be identified to the mailer while it is processing in the United States Postal Service delivery system 230 (FIG. 2).

The method for generating the assignable nine digit field 520 starts at step 530 in which the PLANET code generation application 300 (FIG. 3) receives a command to start generating origin CONFIRM barcodes 500, preferably for return mailpieces included in a batch of mailpieces to be mailed by a mailer. Beginning at step 535, PLANET code generation application 300 retrieves the last generated origin CONFIRM digit barcode used preferably for a preceding batch of mailpieces from the side file sub-database 340 of the origin CONFIRM barcode database 330. Next, this assignable last nine-digit value used for an origin CONFIRM barcode is incremented by a one count, step 540. The current nine digit origin CONFIRM value 520 is then associated with a particular return mailpiece and preferably stored in the origin CONFIRM database 330 (FIG. 3), step 545. A determination is then made as to whether another mailpiece is present in the batch of mail requiring a origin CONFIRM barcode for an associated return mailpiece, step 550. If no, then the current nine digit value 520 used for generating origin CONFIRM barcodes 500 is stored in the sub-database 340 of the origin CONFIRM barcode database 330, step 560. The above process for generating an assignable nine-digit value used for an origin CONFIRM barcode then ends and will repeat itself when another batch of mail requiring origin CONFIRM barcodes for return mailpieces is required, step 570.

If another mailpiece is present in the batch of mail, step 550, then the current nine digits for the assignable nine digit field 520 is increased by one, step 540, and the process returns to the above-described step 545 for this next mailpiece. Thus, the utilization of a random last digit for generation of the origin CONFIRM barcode ensures uniqueness for each return mailpiece and especially for subsequent returned mailpieces that are to be later delivered to the same recipient. It also serves to generate non-repeatable customer index numbers instead of static customer numbers, ensuring customer confidentiality by not using commonly used customer numbers (e.g., social security numbers).

In summary, a method for generating origin and destination CONFIRM barcodes has been described. Although the present invention has been described with emphasis on particular embodiments, it should be understood that the figures are for illustration of the exemplary embodiment of the invention and should not be taken as limitations or thought to be the only means of carrying out the invention. Further, it is contemplated that many changes and modifications may be made to the invention without departing from the scope and spirit of the invention as disclosed.

What is claimed is:

1. A method for generating a PLANET service code for a batch of mailpieces with the PLANET service code having assignable digits, said method comprising the steps of:
retrieving a time of day from a clock source;
prescribing the assignable digits based upon said retrieved time of day;
associating the PLANET service code having the assignable digits with a mailpiece from the batch of mailpieces;
determining if another mailpiece is present in said batch of mailpieces;
incrementing the assignable digits by a one count if another mailpiece is determined present in said batch of mailpieces; and
associating the PLANET service code having the assignable digits incremented by a one count with the another present mailpiece.

2. A method as recited in claim 1, wherein the PLANET service code is a destination CONFIRM barcode for tracking mailpieces in the United States Postal System.

3. A method as recited in claim 1, wherein the retrieved time of day corresponds to the minutes (MM) and seconds (SS) of the current time of day.

4. A method as recited in claim 3, wherein the assignable digits consist of at least four digits.

5. A method as recited in claim 1, wherein the step of associating the PLANET service code includes storing the PLANET service code having the assignable digits in a database in correspondence with a mailpiece.

6. A method for generating a PLANET service code for a batch of mailpieces with the PLANET service code having assignable digits, said method comprising the steps of:
retrieving from a source a last used digit count for a said PLANET service code;
incrementing said last used digit count by a one count;
electronically generating a PLANET service code by implementing said incremented digit count as said assignable digits;
associating generated PLANET service code having the assignable digits with a mailpiece from the batch of mailpieces;
determining if another mailpiece is present in said batch of mailpieces; and
storing at least said incremented digit count in said source if another mailpiece is determined not present.

7. A method for generating a PLANET service code as recited in claim 6, further including the steps of:
incrementing the incremented digit count by a one count if another mailpiece is determined present in said batch of mailpieces; and
electronically generating another PLANET service code by implementing said incremented digit count as said assignable digits;
associating the PLANET service code having the at least four assignable digits incremented by a one count with said another present mailpiece.

8. A method as recited in claim 6, wherein the PLANET service code is an origin CONFIRM barcode for tracking return mailpieces in the United States Postal System.

9. A method as recited in claim 6, wherein the assignable digits consist of at least nine digits.

10. A method as recited in claim 6, wherein the step of associating the PLANET service code includes storing the PLANET service code having the assignable digits in a database in correspondence with a mailpiece.
